(19) United States
(12) Patent Application Publication
(10) Pub. No.: US 2005/0259194 A1
(43) Pub. Date: Nov. 24, 2005

(54) Liquid crystal display and reflecting member for the same

(76) Inventors: Jeong-Hwan Lee, Suwon-si (KR); Jin-Mi Jung, Seoul (KR); Dong-Hoon Kim, Seoul (KR); Jin-Sung Choi, Yongin-si (KR)

Correspondence Address: CANTOR COLBURN, LLP, 55 GRIFFIN ROAD SOUTH, BLOOMFIELD, CT, 06002, US

(21) Appl. No.: 11/131,849

(22) Filed: May 18, 2005

(30) Foreign Application Priority Data
May 18, 2004 (KR) 10-2004-0035164
Jan. 4, 2005 (KR) 10-2005-0000414

(51) Int. Cl. G02F 1/1335

(52) U.S. Cl. 349/64

(57) ABSTRACT

A liquid crystal display device includes a display unit for displaying images, a backlight unit which has a lamp for emitting light to the display unit, a light guiding plate for directing the light emitted from the lamp toward the display unit, and a reflecting member provided adjacent, such as under, the light guiding plate, and an optical film unit provided between the display unit and the backlight unit. The reflecting member includes a first supporting layer, a reflecting layer provided on the first supporting layer, and a bead layer provided on the reflecting layer. By forming the reflecting layer using Al, the production cost lowers and the high brightness characteristic is obtained. By forming the bead layer using silicon based materials or nylon based materials having smooth surface characteristics, it is possible to prevent the light guiding plate and the reflecting layer from being scratched.

This application claims priority to Korean Patent Application Nos. 10-2004-0035164 and 10-2005-0000414, filed on May 18, 2004 and Jan. 4, 2005, respectively, the contents of which in its entirety are herein incorporated by reference.

### BACKGROUND OF THE INVENTION

(a) Field of the Invention

The present invention relates to a liquid crystal display (“LCD”), and more particularly to a reflecting plate for the LCD devices.

(b) Description of the Related Art

Liquid crystal display (LCD) devices would be representative of flat panel display devices. An LCD device includes a pair of panels provided with two kinds of electric field generating electrodes on their inner surfaces, and a liquid crystal layer interposed therebetween. In an LCD device, the variation of the voltage difference between the electric field generating electrodes, i.e., the variation in the strength of an electric field generated by the electrodes, changes the transmittance of light passing through the panels. Thus, desired images are obtained by controlling the voltage difference between the electrodes.

The LCD devices include a backlight unit that produces light, an optical film unit that makes the brightness of the light emitted from the backlight unit uniform, and a display unit that displays images by the uniform light.

In the backlight unit, there are provided a light guiding plate for directing the light towards the display unit, and a reflecting plate that is placed under the light guiding plate for returning the light reflected by the light guiding plate thereto again to obtain higher light efficiency.

A prism-type light guiding plate, commonly used in notebook PCs for high brightness, directs the light in a frontal direction by reflection that omits dispersion of the light, unlike typical light guiding plates that disperse the light and then condense it again. In such a structure, mirror reflection sheets are commonly used instead of dispersing reflection sheets. In this case, the brightness is improved about 20% to 30%.

However, in the prism-type light guiding plate, a prism-shaped area formed at a lower surface thereof, and a reflection sheet are susceptible to scratching due to the friction therebetween.

### SUMMARY OF THE INVENTION

The above and other drawbacks and deficiencies are overcome or alleviated by a liquid crystal display (LCD) device capable of preventing a light guiding plate and a reflecting member from being scratched and capable of reducing a production cost.

In an exemplary embodiment of the LCD device, the LCD device includes a display unit for displaying images, a backlight unit including a lamp for emitting light to the display unit, a light guiding plate for directing light emitted from the lamp towards the display unit, a reflecting member provided under the light guiding plate, and an optical film unit provided between the display unit and the backlight unit.

In one exemplary embodiment, the reflecting member includes a first supporting layer, a reflecting layer provided on the first supporting layer, and a bead layer provided on the reflecting layer.

In another exemplary embodiment, the bead layer is formed with a silicon based material or a nylon based material and includes a plurality of beads sized between about 3 μm to about 15 μm.

In another exemplary embodiment, a mixing ratio of the beads and an adhesive material in the bead layer is about 80:20 to about 20:80.

In another exemplary embodiment, a second supporting layer is further provided between the reflecting layer and the bead layer and has a thickness of about 150 μm to about 250 μm.

In another exemplary embodiment, the reflecting layer is formed with aluminum (Al), and has a thickness of about 500 Å to about 1 μM.

In another exemplary embodiment, an average reflexibility of the reflecting layer is above about 90% in an ultraviolet light region.

In another exemplary embodiment, the optical film unit includes a dispersion film, a prism film, and a brightness enhancing film.

In yet another exemplary embodiment, a reflecting member includes a reflecting layer made of a metal and a protection layer formed on the reflecting layer and made of a silicon based material or a nylon based material.

In another exemplary embodiment, the reflecting layer may be made of Ag or Al.

In another exemplary embodiment, the reflecting member may further include a supporting layer disposed under the reflecting layer.

In another exemplary embodiment, the protection layer may include a plurality of beads.

### BRIEF DESCRIPTION OF DRAWINGS

The above described and other advantages of the present invention will become more apparent by describing exemplary embodiments thereof in more detail with reference to the accompanying drawings, in which:

FIG. 1 is an exploded perspective view of an exemplary embodiment of an LCD device according to the present invention;

FIG. 2 is a cross-sectional view of an exemplary embodiment of an LCD device according to the present invention; and

FIG. 3 shows a reflecting plate employed in a backlight of an exemplary embodiment of an LCD device according to the present invention.

### DETAILED DESCRIPTION OF THE INVENTION

Exemplary embodiments of the present invention will now be described more fully hereinafter with reference to the accompanying drawings, in which exemplary embodiments of the invention are shown. The present invention may, however, be embodied in different forms and should not be construed as being limited to the embodiments set forth herein. Rather, these embodiments are provided so that this disclosure will be thorough and complete, and will fully convey the scope of the invention to those skilled in the art.

In the drawings, the thickness of the layers, films, and regions are exaggerated for clarity. Like numerals refer to like elements throughout. It should be understood that when an element such as a layer, film, region, or substrate is referred to as being “on” another element, it can be directly on the other element or intervening elements may also be present.

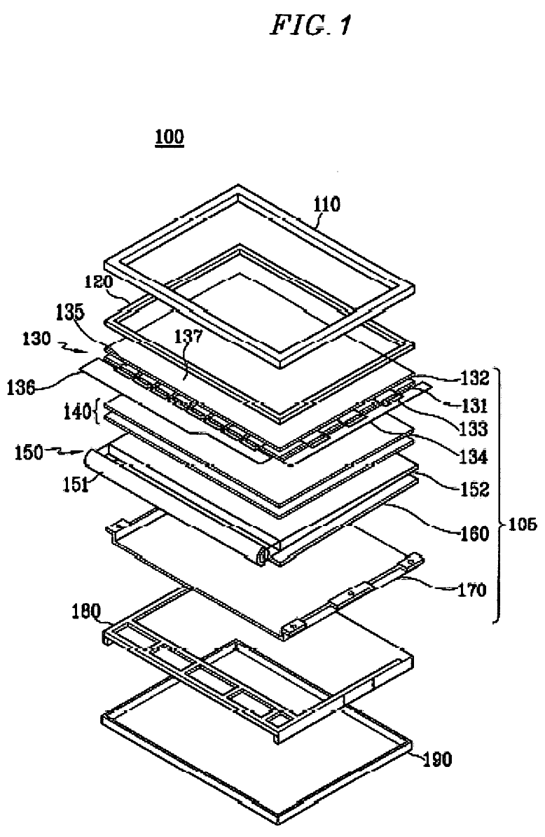

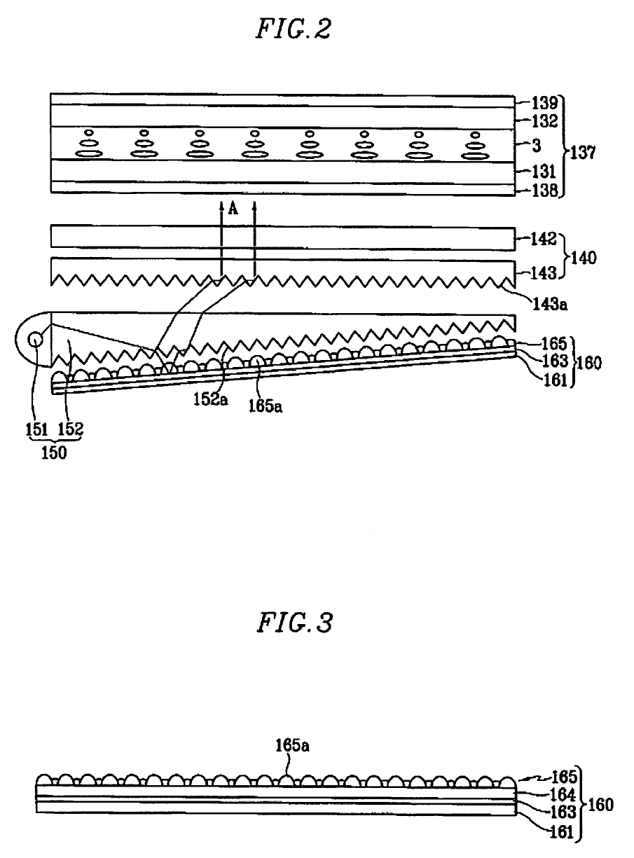

Hereinafter, exemplary embodiments of an LCD device according to the present invention will be described in detail with reference to the accompanying drawings. FIG. 1 is an exploded perspective view of an exemplary embodiment of an LCD device according to the present invention and FIG. 2 is a cross-sectional view of the LCD device in FIG. 1.

As shown in FIG. 1 and FIG. 2, the LCD device 100 comprises an LCD module 105, and front and rear cases 110 and 190 for protecting the LCD module 105. The LCD module 105 includes a display unit 130 for displaying images, a backlight unit 150 placed under the display unit 130 for supplying light to the display unit 130, and an optical film unit 140 provided between the display unit 130 and the backlight unit 150 for making the light emitted from the backlight unit 150 uniform. The display unit 130 includes an LC panel assembly 137, a data tape carrier package (TCP) 135, a data printed circuit board (PCB) 136, a gate TCP 133, and a gate PCB 134. The LC panel assembly 137 includes a thin film transistor (TFT) panel 131 and a color filter panel 132, where the LC panel assembly 137 and TFT panel 131 face each other, and an LC layer 3 (as shown in FIG. 2) interposed therebetween. As further shown in FIG. 2, a lower polarizer 138 and an upper polarizer 139 are provided on outer surfaces of the TFT panel 131 and the color filter panel 132, respectively.

The TFT panel 131 includes a plurality of pixel electrodes (not shown) arranged in a matrix form, a plurality of TFTs (not shown) for selectively transmitting signals to the pixel electrodes, and a plurality of gate lines (not shown) and a plurality of data lines (not shown) connected to the TFTs.

The data lines and the gate lines are electrically connected to the data PCB 136 and the gate PCB 134, respectively, through the data TCP 135 and the gate TCP 133. Accordingly, the data PCB 136 and the gate PCB 134 transmit electric signals to the data lines and the gate lines through the data TCP 135 and the gate TCP 133. In such electric signals, image signals supplied from an external device through the data PCB 136 and the gate PCB 134 or generated by the data PCB 136 and the gate PCB 134, and control signals for controlling them are included.

The color filter panel 132 includes common electrodes that generate an electric field with the pixel electrodes of the TFT panel 131, and color filters for displaying color. In such a structure, the electric field generated when a voltage is applied to the pixel electrodes and common electrodes changes the orientation of LC molecules interposed therebetween.

The backlight unit 150 includes a lamp unit 151 for producing light, and a light guiding plate 152 for directing the light emitted from the lamp unit 151 towards the LC panel assembly 137. While a lamp unit 151 is specifically illustrated, it should be understood that any alternative light source would be within the scope of the backlight unit 150. In the illustrated embodiment, the lamp unit 151 includes at least one lamp and at least one lamp cover for protecting the lamp. The lamp unit 151 shown in FIG. 1 is an edge-type unit that is placed near an edge of the light guiding plate 152.

As shown in FIG. 1 and FIG. 2, the light guiding plate 152 is placed under the LC panel assembly 137 and its size corresponds to the size of the LC panel assembly 137. The light guiding plate 152 is designed such that its thickness is gradually reduced as receding from the lamp unit 151. For example, a first end of the light guiding plate 152 adjacent the lamp unit 151 has a greater thickness than a second end, opposite the first end, of the light guiding plate 152, and the thickness of the light guiding plate 152 decreases gradually from the first end to the second end of the light guiding plate 152. The light guiding plate 152 includes a first surface facing the optical film unit 140 and a second surface facing a reflecting plate 160. The second surface of the light guiding plate 152 includes a prismatic structure having prism-shaped areas 152a.

Such a prism-type light guiding plate 152 directs light in a frontal direction, i.e. in a direction generally towards the LC panel assembly 137, by reflection, thus omitting dispersion of the light, as shown in FIG. 2. This is an improvement over typical light guiding plates that disperse the light and then must condense it again.

The optical film unit 140 is provided on the light guiding plate 152, adjacent the first surface of the light guiding plate 152, to make the brightness of the light uniform, and a reflecting plate 160 is provided under the light guiding plate 152, adjacent the second surface of the light guiding plate 152, to improve light efficiency by returning the light reflected from the light guiding plate 152 thereto again.

The optical film unit 140 includes a plurality of optical films. A reverse prism film 143 is used for directing the light emitted from the backlight unit 150 in the frontal direction, i.e. in direction indicated by arrows A. The reverse prism film 143 includes a prismatic structure having a prism-shaped area 143a. A brightness enhancing film 142 transmits primary “P”-wave and recycles secondary “S”-wave in the light emitted from the backlight unit 150 to enhance the brightness of the light. The brightness enhancing film 142, also included in the unit 140, is placed on the reverse prism film 143. The optical film unit 140 may also include a dispersion film, and/or other layers.

The reflecting plate 160 includes a first supporting layer 161 formed with a high molecule material, such as polyethylene terephthlate (PET) or other suitable material, and having a thickness of about 150 μm to about 250 μm. A reflecting layer 163 is formed on the first supporting layer 161. Considering that a feature of the reflecting plate 160 is to reflect the light emitted from the light guiding plate 150 thereto again to enhance the light efficiency, the reflecting layer 163 can be formed using metallic materials having high reflexibility, for example, silver (Ag).

However, in the prism-type light guiding plate 152, there is little relation between the reflexibility of the reflecting plate 160 and the brightness of the light. This is because the prism-type light guiding plate 152 performs only condensing of the light, directing the light towards the LC panel assembly 137, rather than dispersing the light and re-reflecting it by a reflecting member as in typical light guiding plates. Accordingly, in the LCD device disclosed herein, there is little light directed to the reflecting plate 160 and thus there is little reflection of the light by the reflecting plate 160.

Accordingly, even if the reflecting layer 163 is formed of a relatively low reflexibility in the reflecting plate 160, the resulting brightness of the overall LCD device is nevertheless the same. For instance, when comparing the reflecting layer 163 having the reflexibility of about 95% and that of about 98%, there is no difference in the brightness characteristic between the two layers.

Based on such a fact, it is possible to use aluminum (Al), having a reflexibility that is lower than the reflexibility of a layer of Ag, for the formation of the reflecting plate 160, instead of Ag, which would increase production costs. In such a case, where Al is employed instead of Ag, production cost is lowered and the requirement for the high brightness characteristic is also satisfied.

The reflecting layer 163, such as when made of Al, preferably has a thickness of about 500 Å to about 1 μm since the reflexibility increases as the thickness increases in such a structure. The average reflexibility of the reflecting layer 163 is preferably above about 90% in a visible light region (380 nm to 760 nm).

A bead layer 165, having smooth surface characteristics, is provided on the reflecting layer 163 of the reflecting plate 160. The bead layer 165 is preferably formed out of silicon based materials, nylon based materials, or other similarly performing materials, and a size of each of the beads 165a in the bead layer 165 is preferably about 15 μm or within the range of about 3 μm to about 15 μm. While a range of sizes is disclosed for the beads in the bead layer 165, it should be understood that a reflecting plate 160 used in alternate applications, such as outside of flat panel displays, could utilize beads outside of the described range.

If a protection layer made of a high molecule material is provided on the reflecting layer 163 of the reflecting plate 160 to protect the reflecting layer 163, it may bring scratches in a prism-shaped area 152a on the lower (second) surface of the prism-type light guiding plate 152 by vibration or friction experienced between the light guiding plate 152 and the reflecting plate 160.

To prevent such scratching or other related damage to both the light guiding plate 152 and the reflecting plate 160, a bead layer 165, made of silicon based materials, nylon based materials, or other similarly performing materials having a smooth surface characteristic, is provided on the reflecting layer 163 of the reflecting plate 160.

The bead layer 165 includes a plurality of beads 165a and an adhesive mixed therewith. The mixing ratio of the beads 165a and the adhesive in the bead layer 165 is in the range of about 80:20 to about 20:80. That is, the bead layer 165 can include anywhere from about 80% beads and about 20% adhesive, to about 20% beads and about 80% adhesive, and any combination in between.

Also, as shown in FIG. 3, a second supporting layer 164 made of a transparent high molecule material such as poly ethylene terephthlate (PET), or other similar material, can be further provided on the reflecting layer 163 to protect it. In this case, the bead layer 165 may be formed on the second supporting layer 164.

The display unit 130 and the backlight unit 150 are accommodated in a bottom chassis 170 serving as a container, fixed to a mold frame 180. The mold frame 180 includes relatively large openings through which a rear surface of the bottom chassis 170 is partially exposed, and relatively small openings for facilitating accommodation of circuit elements mounted on the data PCB 136 and the gate PCB 134.

On a portion of the rear surface of the bottom chassis 170 that is exposed through one of the large openings in the mold frame 180, at least an inverter board (not shown) and a signal inverting PCB (not shown) are provided. The inverter board inverts an outer power voltage to a driving voltage and supplies the inverted voltage to the lamp unit 151. The signal inverting PCB is connected to the data PCB 136 and the gate PCB 134 and inverts analog image signals to digital image signals to supply them thereto.

A top chassis 120 is provided on the display unit 130. This top chassis 120 bends the data PCB 136 and the gate PCB 134 to the outside of the mold frame 180 to prevent the display unit 130 from deviating from the bottom chassis 170. The front case 110 overlying the top chassis 120 and the rear case 190 underlying the mold frame 180 are assembled, thus completing the LC display device 100. While a specific arrangement of parts including the cases 110, 190, the chasses 120, 170, and the frame 180 are described and illustrated in conjunction with the specific LC panel assembly 137 and the optical film unit 140, it should be understood that the protective layer 165 in relation to the reflecting plate 160 and the light guiding plate 152 may be employed in LCD devices having alternate elements and arrangements of parts.

Overall, the LCD device 100 described herein offers substantial advantages. By forming the reflecting layer 163 using Al, as opposed to Ag, the production cost lowers while the high brightness characteristic is still obtained. By forming the bead layer 165 using silicon based materials or nylon based materials having a smooth surface characteristic, it is possible to prevent the light guiding plate 152 and the reflecting layer 163 from being scratched or otherwise damaged from friction between the parts.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification. It is intended that the invention not be limited to the particular embodiments disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A liquid crystal display comprising:
a display unit for displaying images;
a backlight unit including a lamp for emitting light to the display unit and a light guiding plate for directing the light emitted from the lamp towards the display unit;
a reflecting member provided adjacent the light guiding plate; and
an optical film unit provided between the display unit and the backlight unit,
wherein the reflecting member includes a first supporting layer, a reflecting layer provided on the first supporting layer, and a bead layer provided on the reflecting layer.

2. The liquid crystal display of claim 1, wherein the bead layer comprises a silicon based material or a nylon based material.

3. The liquid crystal display of claim 1, wherein the bead layer includes a plurality of beads, wherein each bead in the plurality of beads has a diameter falling with a range of about 3 μm to about 15 μm.

4. The liquid crystal display of claim 1, wherein the bead layer further includes an adhesive material mixed with the plurality of beads, and wherein a mixing ratio of the beads and the adhesive material is about 80:20.

5. The liquid crystal display of claim 1 further comprising a second supporting layer between the reflecting layer and the bead layer.

6. The liquid crystal display of claim 1, wherein the reflecting layer comprises aluminum.

7. The liquid crystal display of claim 1, wherein a thickness of the reflecting layer falls within a range of about 500 Å to about 1 μm.

8. The liquid crystal display of claim 1, wherein a thickness of the first supporting layer falls within a range of about 150 μm to about 250 μm.

9. The liquid crystal display of claim 1, wherein an average reflexibility of the reflecting layer is above about 90% in an ultraviolet light region.

10. The liquid crystal display of claim 1, wherein the optical film unit includes a prism film and a brightness enhancing film.

11. A reflecting member comprising:
a reflecting layer comprising metal; and
a protection layer formed on the reflecting layer, wherein the protection layer comprises a silicon based material or a nylon based material.

12. The reflecting member of claim 11, wherein the reflecting layer comprises silver.

13. The reflecting member of claim 11, wherein the reflecting layer comprises aluminum.

14. The reflecting member of claim 11, further comprising a supporting layer disposed adjacent the reflecting layer.

15. The reflecting member of claim 11, wherein the protection layer includes a plurality of beads.
